(19) United States
(12) Patent Application Publication
(10) Pub. No.: US 2007/0283047 A1
(43) Pub. Date: Dec. 6, 2007

(54) System and method for processing alphanumeric characters for display on a data processing device

(76) Inventors: Ronald L. A. Theis, Palo Alto, CA (US); Michael Morrissey, San Francisco, CA (US)

Correspondence Address: Thomas C. Webster;Blakely, Sokoloff, Taylor & Zafman LLP, Seventh Floor, 12400 Wilshire Boulevard, Los Angeles, CA, 90025-1030, US

(21) Appl. No.: 10/263,145

(22) Filed: Oct. 1, 2002

(51) Int. Cl. G06F 15/16

(52) U.S. Cl. 709/246

(57) ABSTRACT

A system is described comprising: character analysis logic configured at a data service to analyze original content requested by a data processing device, the original content containing one or more original characters; a database containing display capabilities and limitations of said data processing device; the character analysis logic being further configured to determine, based on the analysis and the database, whether any original characters within the original content are not displayable by the data processing device; and character conversion logic configured at the data service to convert the original content into unoriginal content comprised of one or more displayable characters if one or more of the original characters are not displayable by the data processing device, each of the displayable characters corresponding to one or more of the original characters which are not displayable on the data processing device; wherein the data service is configured to transmit the converted content to the data processing device. The above amendments do not add any new matter. They merely correct matters of form and more clearly express the contents of the invention.

### BACKGROUND

1. Field of the Invention

This invention relates generally to the field of data processing systems. More particularly, the invention relates to an improved system and method for processing alphanumeric characters at a data service so that they may be properly rendered on a data processing device.

2. Description of the Related Art

In order for a data processing device such as a personal computer or personal information manager (“PIM”) to display a particular alphanumeric character or group of characters, the alphanumeric character(s) must be installed on the data processing device. For example, in order for a data processing device to display non-English characters, such as the “é” character (“e” with an “accent egu”), a character set which includes those characters must first be installed on the data processing device.

In operation, if a user is browsing the Internet with a data processing device and attempts to download a Web page containing unsupported characters, the user will be asked if he/she would like to install the character set that supports the characters. Installing an entire character set for the purpose of viewing a single Web page may be somewhat bothersome to the end user, particularly if the network connection between the Web server and the user's data processing device is slow.

In addition, even after a new character set is installed, the same character may be represented in multiple ways, some of which the data processing device may not be capable of processing. For example, in the Unicode character format, the letter “e with grave” can be represented as a single “e with grave” character, or as an “e” character followed by a “modifier with grave” character. Some languages can have complex combinations involving multiple modifiers, such as multiple accents above and below characters.

One of the challenges with using multiple character descriptions is string comparison. To a data processing device, the above two methods of representing the letter “e with grave” are quite different. A string using the first representation would contain a completely different sequence of bytes than a string using the second representation. When compared against each other, these strings would appear to be unequal, when in fact they represent the same letter.

Accordingly, what is needed is an improved system and method for processing and displaying characters on a data processing device. What is also needed is a system and method which may be implemented transparently to the end user, without the need for manual installation of new character sets or additional character rendering software.

### SUMMARY

A method is described comprising: analyzing original content requested by a data processing device at a data service, the content containing one or more original characters; determining at the service, based on the analysis, whether any original characters within the original content are not displayable by the data processing device; and if one or more of the original characters are not displayable by the data processing device, converting the original content into unoriginal content comprised of one or more displayable characters, each of the displayable characters corresponding to one or more of the original characters which are not displayable on the data processing device; and transmitting the converted content to the data processing device.

Also described is a system comprising: character analysis logic configured at a data service to analyze original content requested by a data processing device, the original content containing one or more original characters; the character analysis logic being further configured to determine, based on the analysis, whether any original characters within the original content are not displayable by the data processing device; and character conversion logic configured at the data service to convert the original content into unoriginal content comprised of one or more displayable characters if one or more of the original characters are not displayable by the data processing device, each of the displayable characters corresponding to one or more of the original characters which are not displayable on the data processing device; wherein the data service is configured to transmit the converted content to the data processing device.

### BRIEF DESCRIPTION OF THE DRAWINGS

A better understanding of the present invention can be obtained from the following detailed description in conjunction with the following drawings, in which:

FIG. 1 illustrates one embodiment of a data processing service communicating with a data processing device.

FIG. 2 illustrates character processing logic according to one embodiment of the invention.

FIG. 3 illustrates a character processing method according to one embodiment of the invention.

### DETAILED DESCRIPTION OF PREFERRED EMBODIMENTS

Described below is a system and method for coordinating between a plurality of e-mail accounts. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### Embodiments of a Data Processing Service

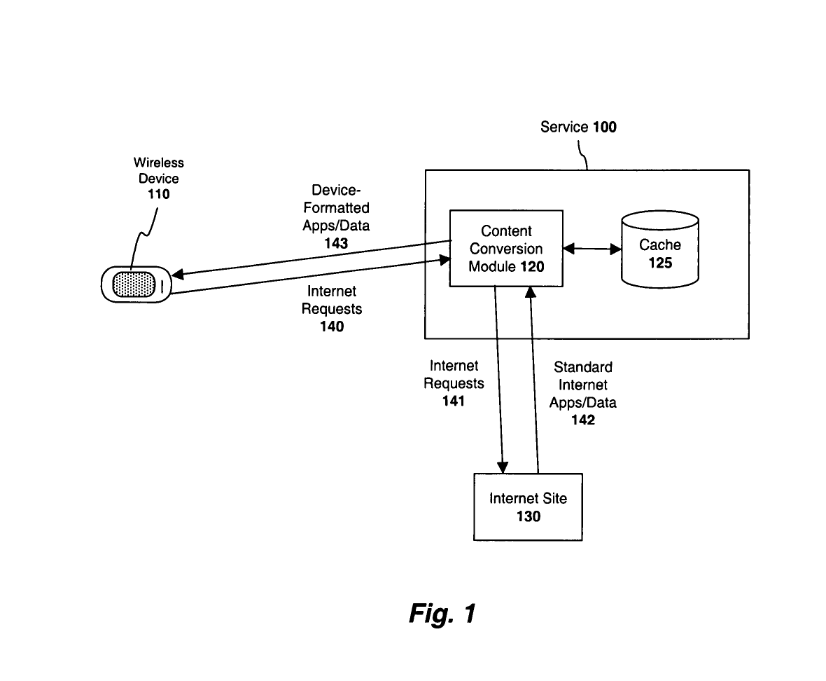

Embodiments of the invention may be implemented on a data processing service 100 such as that illustrated generally in FIG. 1. The service 100, which may be comprised of one or more servers, provides a portal through which data processing devices 110 may access content (e.g., Web pages, multimedia content, e-mail, . . . etc) from external Internet sites 130. Embodiments of such a service 100 are described in co-pending application entitled NETWORK PORTAL SYSTEM, APPARATUS AND METHOD, Ser. No. 09/714,897, Filed Nov. 15, 2000 (hereinafter “Network Portal Application”), which is assigned to the assignee of the present application and which is incorporated herein by reference. Certain features of the service 100 will now be described followed by a detailed description of a system and method for processing alphanumeric characters.

In one embodiment, the service 100 converts standard applications and data into a format which each wireless data processing device 110 can properly interpret. Thus, as illustrated in FIG. 1, one embodiment of the service 110 includes a content conversion module 120 for processing requests for Internet content 140. More particularly, the service 100 acts as a proxy for the data processing device 110, forwarding Internet requests 140, 141 to the appropriate Internet site 130 on behalf of the data processing device 110, receiving responses from the Internet site 130 in a standard Internet format (e.g., Web pages with embedded audio/video and graphical content, e-mail messages with attachments, . . . etc), and converting the standard Internet responses 124 into a format which the data processing device 110 can process (e.g., bytecodes as described in the Network Portal Application).

For example, the conversion module 120 may include a hypertext markup language (“HTML”) rendering module (not shown) for interpreting HTML code and downloading any embedded content in the HTML code (e.g., graphics, video, sound, . . . etc) to the service 100. The conversion module 120 may then combine the HTML code and embedded content and generate a set of bytecodes for accurately reproducing the requested content on the data processing device 110. As described above, in one embodiment, the bytecodes may be Java bytecodes/applets. However, the conversion module 120 may generate various other types of interpreted and/or non-interpreted code, depending on the particular type of data processing device 110 being used (e.g., one with an interpreter module or one without).

Because one embodiment of the service 100 maintains an intimate knowledge of the capabilities/configuration of each data processing device 110 (e.g., screen size, graphics/audio capabilities, available memory, processing power, user preferences, . . . etc) it can reconstruct the requested Internet content accurately, while at the same time minimizing the bandwidth required to transmit the content to the device 110. For example, the conversion module 120 may perform pre-scaling and color depth adjustments to the requested content so that it will be rendered properly within the data processing device's 110's display. In making these calculations, the conversion may factor in the memory and processing power available on the data processing device 110. In addition, the conversion module 120 may compress the requested content using a variety of compression techniques, and thereby preserve network bandwidth.

In one embodiment, the conversion module 120 will simply discard Internet content which either cannot be reproduced on the data processing device 110, or which the user has indicated that he/she does not want to be reproduced on the portal device. For example, a user may indicate that he/she does not want sounds to be generated on the data processing device 110 or that he/she does not want advertisements transmitted to the data processing device 110. The conversion module 120 will then remove any sounds or advertisements embedded in the requested Web page (or other requested Internet content). Because HTML rendering and other advanced processing of Internet content/data is offloaded to the service 100 as described above, the data processing device 110 can be manufactured using a low power microprocessor or microcontroller, thereby lowering the cost of manufacture and/or the energy consumed by the device 110.

In one embodiment, when a particular Web page or other Internet object has been converted into a format suitable for execution on the data processing device 110 the formatted page/object may be stored locally on a cache 125 maintained at the service 100. The next time the content is requested, the conversion module 120 may simply read the previously-generated code from the local cache 125 (i.e., it will no longer need to retrieve the content from remote locations to reconstruct the code).

Various caching techniques and algorithms may be implemented to ensure that the cache 125 is storing Internet data efficiently (i.e., resulting in an acceptable percentage of cache ‘hits’) and that the data is current. For example, the service 100 may cache the most frequently-requested Internet data (e.g., the Yahoo™ home page), and may remove content from the cache based on a least-recently used caching policy. In addition, to ensure that data stored in the cache is current, the service 100 may compare the version of the data stored in the cache 125 with the version of data stored at the remote Internet site 130 when the data is requested. Similarly, the service 100 may store data in the cache 125 for some predetermined period of time before checking the remote server 130 for a new version. Various other Internet caching techniques may be employed while still complying with the underlying principles of the invention (e.g., those defined in the Internet Caching Protocol (“ICP”) and/or the Cache Array Routing Protocol (“CARP”)).

### Character Processing

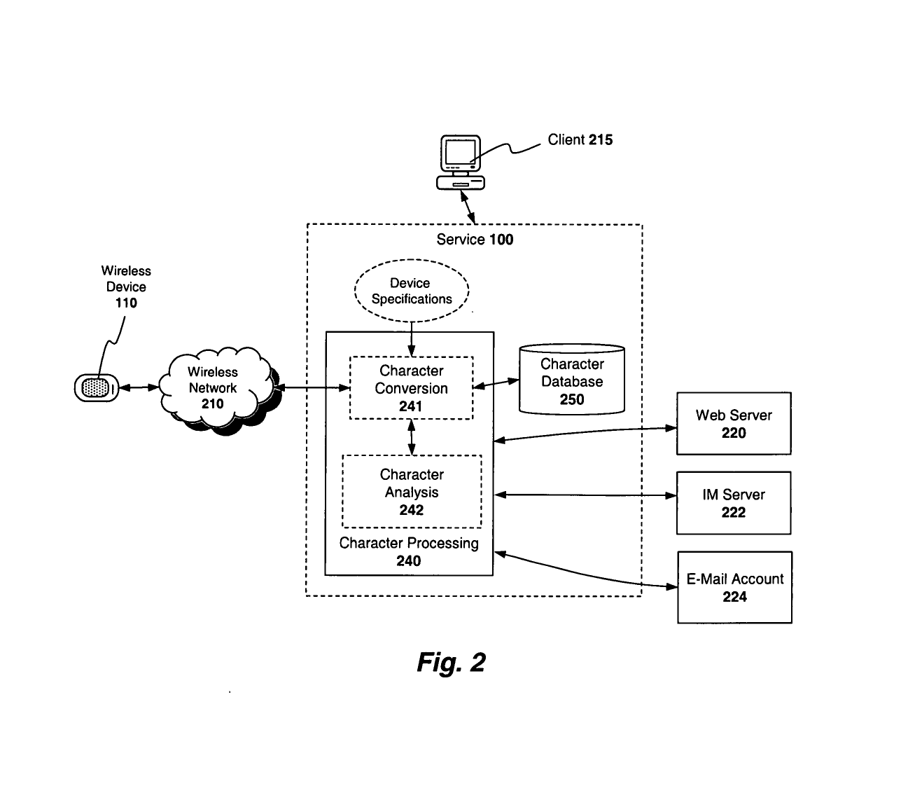

One embodiment of the service 100, illustrated in FIG. 2, is comprised of a character processing module 240 for processing content containing alphanumeric characters. Various types of character-based content may be processed by the character processing module 240 including, by way of example but not limitation, Web pages from Web servers 220, e-mail messages from e-mail accounts 224 and/or instant messages from instant messaging servers 222. Various alternate types of content may be processed by the character processing module 240 while still complying with the underlying principles of the invention. In addition, the servers 220, 222, and 224 which supply the content to the data processing device 110 may be internal servers (maintained by the data processing service 100) and/or external servers (maintained by third-party organizations).

In one embodiment of the invention, the character processing module 240 is comprised of a character conversion module 241 for converting/replacing characters based on the character processing capabilities of each wireless device (e.g., character sets installed, screen resolution, . . . etc), and a character analysis module 242 for identifying character types and maintaining a link between converted content/characters sent to the wireless device 110 and the original content stored at the service 100. Thus, the character processing module 240 operates in a similar manner to the content conversion module 120 described above except that it specifically converts/replaces alphanumeric characters for rendering on the wireless device 110.

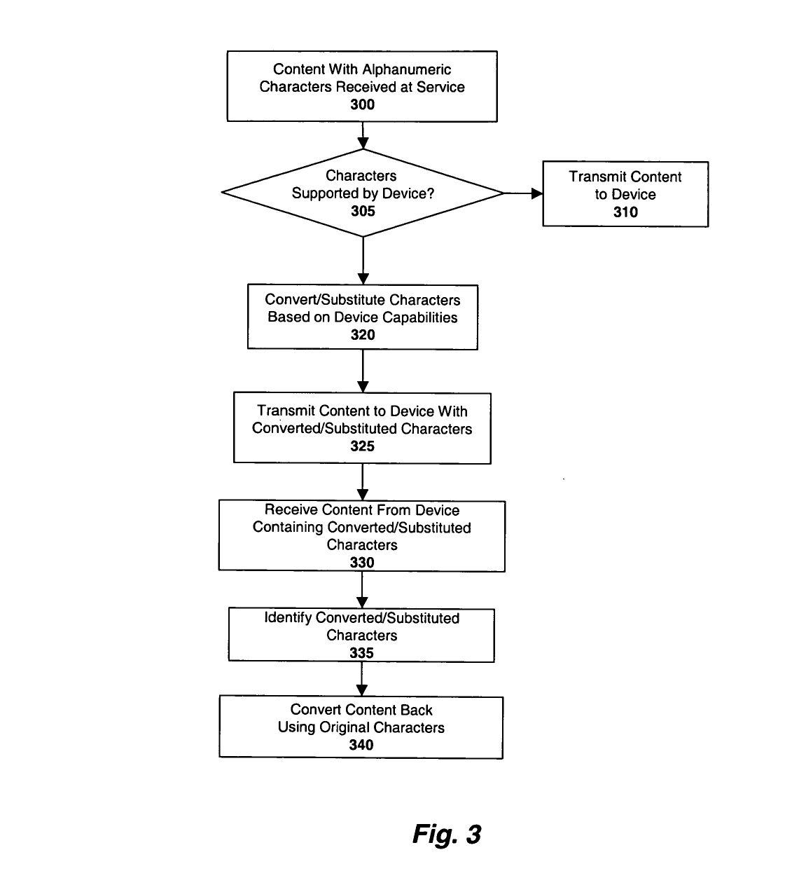

FIG. 3 illustrates one embodiment of a method employed by the system illustrated in FIG. 2. At 300, when the user requests a new e-mail message, Web page, instant message or other type of electronic content, the service 100 retrieves the content on behalf of the user. Alternatively, the requested content may already be stored at the service (e.g., on an internal e-mail or Web server). At 305, the character analysis module 240 determines whether the characters embedded within the requested content are supported by the data processing device 110. In one embodiment, the character analysis module 242 makes this determination by searching through the requested content and comparing the identified characters or character sets with those known to be supported by the device 110. In certain cases, an indication of the characters used in the requested content may be stored in a particular location within the requested content (e.g., within a header field).

If all characters within the requested content are supported by the data processing device 110, then, at 310, the service 100 transmits the content to the wireless device without making character set modifications. Prior to transmission, however, the service 100 may convert other aspects of the requested content so that the content may be properly rendered by the wireless device 110 (e.g., by converting embedded images, modifying document formatting, . . . etc, as described above). For example, if the content is an HTML document and the wireless device 110 cannot interpret HTML, the service 100 may convert the HTML content into a format which is interpretable by the device.

If the character analysis module 242 determines that the requested content contains characters which are not supported by the data processing device 110, then, at 320, the character analysis module 242 identifies the unsupported characters to the character conversion module 241, which attempts to replace the unsupported characters with characters that the data processing device 110 can process and render. In one embodiment, the service 100 maintains a character set database 250, which contains an up-to-date list of all known character sets and a corresponding list of potential replacement characters and/or character sets (i.e., character sets that the data processing device can process and display). In one embodiment, the content conversion module 241 initially attempts to identify known replacement characters from the replacement character list. For example, if a particular Web page contains curly quotes (“ ”) but the device only supports straight quotes, then the content conversion module 241 will replace the curly quotes with straight quotes. Similarly, if the device is unable to display the copyright character “©” or the registered trademark character “®” then the content conversion module 241 may replace these characters with an appropriate sequence of characters that the device is capable of displaying such as, for example, “(c)” and “(r),” respectively.

As mentioned above, some languages can have complex combinations involving multiple modifiers, such as multiple accents above and below characters. In Unicode, for example, the letter “e with grave” may be represented as a single “e with grave” character, or as an “e” character followed by a “modifier with grave.” In one embodiment, these multiple combination character strings are normalized in a consistent manner by the character conversion module 241 before being transmitted to the data processing device 110. For example, the character conversion module 241 may be configured to consistently convert an “e” followed by a “modifier with grave” character into a single “e with grave” character. Various other multiple-combination characters may be consistently processed by the character conversion module while still complying with the underlying principles of the invention.

If the content conversion module 241 is unsuccessful at identifying an exact replacement character, then, in one embodiment, it will attempt to identify the closest suitable replacement. For example, if the device is not capable of displaying the “ê” character, the service 100 may simply convert it to a standard “e” or “E.” In one embodiment, the character conversion module 241 may generate a replacement character on the fly by analyzing the graphical content of the unsupported character (and based on the display capabilities of the data processing device 110). For example, the character conversion module 241 may graphically generate a bitmap of a the “ê” character which the device is capable of rendering.

In one embodiment, the original characters that the data processing device 110 does not support are preserved on the service 100. For example, the character processing module 240 may maintain a link between converted content transmitted to the data processing device 110 and the original content stored on the service 100 (and/or on external servers servers). Thus, when the user accesses content such as an e-mail message or a Web-based electronic calendar from a personal computer (e.g., client 215) the content will appear in its original format (i.e., using the unsupported characters). By contrast, when the user accesses the same content from the data processing device 110, the content will appear with the converted/replaced characters.

Referring once again to FIG. 3, at 330, the service 100 receives content from the device which contains previously-converted/substituted characters. For example, the user may reply to a previously converted e-mail message using the “reply with history” feature. Alternatively, the user may have manually entered characters on the device 110 identifying an unsupported character (e.g., the user may have entered “(c)” indicating the copyright symbol ©). In ether case, in one embodiment of the invention, at 335, the character analysis module 242 searches the content transmitted from the device to locate the converted/substituted characters. The character analysis module 242 provides this information to the character conversion module which, at 340, converts the content back to its original format prior to transmitting it to its destination (e.g., the e-mail addressee). Alternatively, if the destination is another data processing device with the same character display capabilities as the user's data processing device, then the character conversion module 241 may retain the converted/substituted characters so that they may be properly displayed on the destination device.

In one embodiment, the character conversion module 241 attaches the needed characters (e.g., a subset of the needed font) to the data transmission. The device may then use the attached characters to accurately render the content. For example, if an e-mail containing Japanese characters is addressed to the data processing device 110 and the device does not support Japanese characters, the attachment conversion module 241 may attach to the e-mail message only those glyphs needed to display the Japanese characters. This technique of attaching needed glyphs/characters to data transmissions saves a considerable amount of bandwidth and storage capacity on the data processing device. Rather than requiring a non-Japanese device to have a full 6000+ character font installed, only a select group needed to reproduce the message will be transmitted and stored on the device.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while embodiments of the invention are illustrated with respect to a wireless device 110 communicating over a wireless network 210, it should be noted that many of these embodiments may be employed for a non-wireless client 215 communicating over a standard, wired network. It should also be noted that the term “character” is used broadly herein to include a variety of character sets including hieroglyphic character sets (e.g., Japanese character sets, Chinese character sets, . . . etc) as well as alphabetical character sets. Accordingly, the scope and spirit of the invention should be judged in terms of the claims which follow.

1.-29. (canceled)

30. A method comprising:
performing an analysis of original content at a data service;
determining at the data service, based on the display capabilities of a first data processing device and the analysis of the original content, whether the original content is not displayable by the first data processing device;
if the original content is not displayable by the first data processing device, converting the original content into converted content that is displayable on the first data processing device;
transmitting the converted content to the first data processing device.
storing the original content at the data service;
receiving at the data service a response from the first data processing device, the response comprising the converted content; and
in response to receiving the response at the data service, transmitting the original content from the data service to a second data processing device.

31. The method of claim 30 wherein the original content comprises one or more original characters, the step of determining whether the original content is not displayable by the first data processing device comprises the step of determining whether any of the original characters are not displayable by the first data processing device, and the step of converting the original content into converted content comprises the step of converting the original characters into one or more displayable characters, each of the displayable characters corresponding to one or more of the original characters which are not displayable on the first data processing device.

32. The method of claim 31 wherein the original content comprises an e-mail message.

33. The method of claim 31 wherein the original content comprises an instant message.

34. The method of claim 31 wherein the original characters comprise hieroglyphic characters.

35. The method of claim 34 wherein the hieroglyphic characters comprise a character selected from the group of Japanese characters and Chinese characters.

36. The method of claim 30 wherein the second data processing device is a personal computer.

37. The method of claim 36 wherein the original content comprises a first e-mail message and the response is a second e-mail message sent by the first data processing device.

38. The method of claim 30 further comprising the step of maintaining a database of the display capabilities of the first data processing device.

39. The method of claim 30 further comprising the step of performing one or more compression techniques on the converted content to reduce bandwidth required to transmit the converted content to the first data processing device.

40. The method of claim 30 wherein the original content comprises a web page.

41. The method of claim 40 wherein the web page comprises an embedded object, the step of converting the original content into converted content that is displayable on the first data processing device comprising the step of converting the embedded object from an original format into a converted format.

42. The method of claim 41 wherein the embedded object is an image.

43. The method of claim 41 wherein the embedded object is an audio stream.

44. A system comprising:
a content analysis logic configured to analyze original content at a data service to determine, based on the display capabilities of a first data processing device and the analysis of the original content, whether the original content is not displayable by the first data processing device;
a content conversion logic to convert the original content into converted content that is displayable on the first data processing device, if the original content is not displayable by the first data processing device;
a communication apparatus for transmitting the converted content from the data service to the first data processing device and receiving a response from the first data processing device, the response comprising the converted content;
a memory for storing the original content at the data service; and
logic for transmitting the original content from the memory to a second data processing device in response to receiving the response at the data service.

45. The system of claim 44 wherein the original content comprises one or more original characters, the content analysis logic being further configured to determine whether any of the original characters are not displayable by the first data processing device, and the content conversion logic being further configured to convert the original characters into one or more displayable characters, each of the displayable characters corresponding to one or more of the original characters which are not displayable on the first data processing device.

46. The system of claim 45 wherein the original content comprises an e-mail message.

47. The system of claim 45 wherein the original content comprises an instant message.

48. The system of claim 45 wherein the original characters comprise hieroglyphic characters.

49. The system of claim 48 wherein the hieroglyphic characters comprise a character selected from the group of Japanese characters and Chinese characters.

50. The system of claim 44 wherein the second data processing device is a personal computer.

51. The system of claim 50 wherein the original content comprises a first e-mail message and the response is a second e-mail message sent by the first data processing device.

52. The system of claim 44 further a database of the display capabilities of the first data processing device, the content analysis logic being configured to access the database.

53. The system of claim 44 wherein the communication apparatus further comprises compression logic to compress the converted content to reduce bandwidth required to transmit the converted content to the first data processing device.

54. The system of claim 44 wherein the original content comprises a web page.

55. The system of claim 54 wherein the web page comprises an embedded object, the content conversion logic comprising logic to convert the embedded object from an original format into a converted format.

56. The system of claim 55 wherein the embedded object is an image.

57. The system of claim 55 wherein the embedded object is an audio stream.
